(19) United States
(12) Patent Application Publication
(10) Pub. No.: US 2015/0025877 A1
(43) Pub. Date: Jan. 22, 2015

(54) CHARACTER INPUT DEVICE, CHARACTER INPUT METHOD, AND COMPUTER PROGRAM PRODUCT

(71) Applicant: KABUSHIKI KAISHA TOSHIBA, Tokyo (JP)

(72) Inventors: Kouji UENO, Mishima-shi (JP); Tomoo IKEDA, Tokyo (JP); Taira ASHIKAWA, Kawasaki-shi (JP); Kouta NAKATA, Tokyo (JP)

(21) Appl. No.: 14/333,884

(22) Filed: Jul. 17, 2014

(30) Foreign Application Priority Data
Jul. 19, 2013 (JP) 2013-151108

(51) Int. Cl. G06F 3/023; G06F 17/27

(52) U.S. Cl. CPC G06F 3/0237; G06F 17/276
USPC 704/9

(57) ABSTRACT

According to an embodiment, a character input device includes a first obtainer, a determiner, a first generator, and an outputter. The first obtainer receives an input of characters from a user and obtains an input character string. The determiner infers, from the input character string, word notations intended by the user and relations of connection between the word notations and to determine routes each of which represents the relation of connection having a high likelihood of serving as a notation candidate intended by the user. The first generator extracts, from a group of word notations included in the routes, the word notations to be output and generate layout information used in outputting the extracted word notations as the notation candidates. The outputter outputs the layout information.

### CROSS-REFERENCE TO RELATED APPLICATION(S)

This application is based upon and claims the benefit of priority from Japanese Patent Application No. 2013-151108, filed on Jul. 19, 2013; the entire contents of which are incorporated herein by reference.

### FIELD

Embodiments described herein relate generally to a character input device, a character input method, and a computer program product.

### BACKGROUND

While inputting characters in a computer system, if a conversion operation is performed with respect to the reading of an input character string, then an inference result is presented in the form of a group of notation candidates that are believed to be equivalent to that reading. In that regard, typically, a technology is known that aims at reducing the inconvenience faced while performing the conversion operation.

However, in the conventional technology, in order to perform a character input in an accurate manner, it is necessary to constantly keep looking at the screen on which the input result is displayed. For that reason, the conventional technology is not very user-friendly.

### BRIEF DESCRIPTION OF THE DRAWINGS

FIG. 1 is a diagram illustrating a functional configuration example of a character input device according to a first embodiment;

FIG. 2 is a diagram illustrating an example of an input character string according to the first embodiment;

FIG. 3 is a diagram illustrating an example of a word notation list according to the first embodiment;

FIG. 4 is a diagram illustrating an example of a directed acyclic graph according to the first embodiment;

FIG. 5 is a diagram illustrating an example of N number of best routes according to the first embodiment;

FIG. 6 is a flowchart for explaining an example of operations performed during an input of characters according to the first embodiment;

FIG. 7 is a flowchart for explaining an example of operations performed during extraction of words according to the first embodiment;

FIG. 8 is a diagram illustrating an example of the result of word extraction according to the first embodiment;

FIG. 9 is a diagram illustrating output examples of layout information according to the first embodiment;

FIG. 10 is a diagram illustrating a functional configuration example of the character input device according to a second embodiment;

FIG. 11 is a flowchart for explaining an example of operations performed during an input of characters according to the second embodiment;

FIG. 12 is a diagram illustrating an example of a keypad according to a third embodiment;

FIG. 13 is a diagram illustrating an example of a word notation list according to the third embodiment;

FIG. 14 is a diagram illustrating an example of a directed acyclic graph according to the third embodiment;

FIG. 15 is a diagram illustrating an example of N number of best routes according to the third embodiment;

FIG. 16 is a diagram illustrating an output example of layout information according to the third embodiment; and

FIG. 17 is a diagram illustrating a configuration example of the character input device according to the embodiments.

### DETAILED DESCRIPTION

According to an embodiment, a character input device includes a first obtainer, a determiner, a first generator, and an outputter. The first obtainer receives an input of characters from a user and obtains an input character string. The determiner infers, from the input character string, word notations intended by the user and relations of connection between the word notations and to determine routes each of which represents the relation of connection having a high likelihood of serving as a notation candidate intended by the user. The first generator extracts, from a group of word notations included in the routes, the word notations to be output and generate layout information used in outputting the extracted word notations as the notation candidates. The outputter outputs the layout information.

Various embodiments are described below in detail with reference to the accompanying drawings.

### First Embodiment

### Brief Overview

Given below is the explanation about a function (hereinafter, called a “character input function”) provided in a character input device according to a first embodiment. The character input device according to the first embodiment receives input of characters from a user and obtains an input character string. Then, from the input character string, the character input device according to the first embodiment infers the user-intended word notations and the relations of connection (combinations) between the word notations; and determines a plurality of connection routes each of which has a high likelihood (a high probability) of serving as the user-intended notation candidate (conversion candidate). Subsequently, from the group of word notations included in the connection routes, the character input device according to the first embodiment extracts the word notations to be output. Moreover, the character input device according to the first embodiment generates layout information that is used for the purpose of outputting, as notation candidates, a word notation string of the combinational route having the highest likelihood of serving as the user-intended notation candidate as well as the extracted word notations. Then, the character input device according to the first embodiment outputs the generated layout information. These are the functions provided in the character input device according to the first embodiment.

While inputting characters in a computer system, if a conversion operation is performed with respect to the reading of an input character string, then an inference result is presented in the form of a group of notation candidates that are believed to be equivalent to that reading. In response, the user carefully reads the displayed group of notation candidates to find the intended notations, and selects the intended notations to confirm the input. More particularly, for example, in the case of Japanese language, firstly, the user inputs a character string (a pre-conversion character string), which is equivalent to the Japanese reading, in hiragana or katakana by means of the kana input or the roman letter input. Then, the user performs a predetermined key operation and instructs conversion with respect to the Japanese reading that has been input. As a result, the Japanese notations believed to be equivalent to the input Japanese reading are displayed on a screen as a group of notation candidates. In response, the user searches the group of notation candidates for the intended Japanese notations with respect to the input Japanese reading, and selects those Japanese notations on the screen. As a result, the Japanese character input gets confirmed.

Such a character input operation is common among languages, such as Chinese language, that have a large number of characters. Moreover, in recent years, the technology of presenting an inference result in the form of a group of notation candidates is also implemented for the following purpose. For example, in an environment, such as an environment of a cellular phone, in which a high-speed input is difficult to perform; notation candidates are inferred and presented based on a vague input (abbreviated input) and confirmation of the final input result is prompted.

In such a situation, typically, the notation candidates are presented upon being separated according to phrases or words for practical purposes. However, the separation according to phrases or words or the notation candidates presented with respect to the reading represents nothing more than the result of inference from the input character string, and may be different from the intention of the user (i.e., there may be inaccuracy in the inference). For example, assume that a user has the intention of converting a sentence into Japanese notation having the meaning of “there are two chickens in the backyard”, and accordingly inputs a Japanese reading that is pronounced as “u-ra-ni-wa-ni-wa-ni-wa-to-ri-ga-i-ru”. In this case, depending on the accuracy of inference, there is a possibility that a Japanese notation candidate that is pronounced as “u-ra-ni-wa-ni-wa-ni-wa-to-ri-ga-i-ru” but that has the meaning of “there is a clay figure collector in the backyard” is presented. Hence, in order to obtain an accurate character input result, the user needs to repeat the conversion operation. That is a cumbersome task for the user. For example, if the Japanese notation candidate meaning “there is a clay figure collector in the backyard” is presented, then the pre-conversion Japanese reading “ha-ni-wa” corresponding to the post-conversion Japanese notations that mean “clay figure” needs to be re-separated into “ha” and “ni-wa”, and the correct Japanese notations need to be selected from the post-reconversion group of Japanese notations. In that regard, conventionally, a technology has been proposed that aims at reducing the inconvenience caused during the conversion operations by means of reducing the number of such operations and reducing the volume of the group of notation candidates that needs to be meticulously read.

However, in the conventional technology, the operations such as instructing a conversion, selecting the intended notations, and correcting the separation according to phrases or words are absolutely necessary. Hence, in order to perform an accurate character input, it is necessary to constantly keep looking at the screen on which the input result is displayed. For that reason, for example, in the case of performing the character input for the purpose of taking down notes using the intended notations while listening to a meeting or a lecture (i.e., while listening to a person talk); it becomes difficult to concentrate on the content of the meeting or the lecture. That is, in such a situation, it is desirable that the character input can be carried on without having to perform the operations such as instructing a conversion, selecting the intended notations, and correcting the separation according to phrases or words. In order to enable the character input in such desirable manner, it is necessary that the intended notations are presented automatically as well as at a high probability from the input character string based on the character conversion technology. However, in the conventional technology, it is difficult to provide an environment that enables presentation in such a manner. Hence, the conventional technology is not very user-friendly.

In that regard, the character input device according to the first embodiment infers, from the input character string, the user-intended word notations and the relations of connection (combinations) between the word notations; and determines a plurality of connection routes each of which has a high likelihood of serving as the user-intended notation candidate. Subsequently, from the group of word notations included in the connection routes, the character input device according to the first embodiment extracts the word notations to be displayed. In this way, the character input device according to the first embodiment is configured to present a word notation string of the connection route having the highest likelihood of serving as the user-intended notation candidate as well as to present the extracted word notations to the user.

As a result, without making the user perform the operations such as instructing a conversion, selecting the intended notations, and correcting the separation according to phrases or words; the character input device according to the first embodiment can present the user-intended notations automatically as well as at a high probability from the input character string. With that, even in a situation in which, for example, the user is listening to a lecture and it is difficult for him or her to constantly look at the screen; the character input device according to the first embodiment can provide a service that enables the user to efficiently carry on with the character input with bare minimum attentiveness. That is, the character input device according to the first embodiment enables achieving enhancement in the user-friendliness.

Given below is the explanation of a functional configuration of the character input device according to the first embodiment and the operations performed in the character input device. In the first embodiment, the character input device is assumed to be a typical information processing device, and the explanation is given for an example in which the character input device is used to perform Japanese language input using a keyboard. Moreover, in the following explanation, a character or a character string equivalent to a pre-conversion Japanese reading is expressed as reading “•”, while a character or a character string equivalent to a post-conversion Japanese notation is expressed as notation “•”.

Functional Configuration

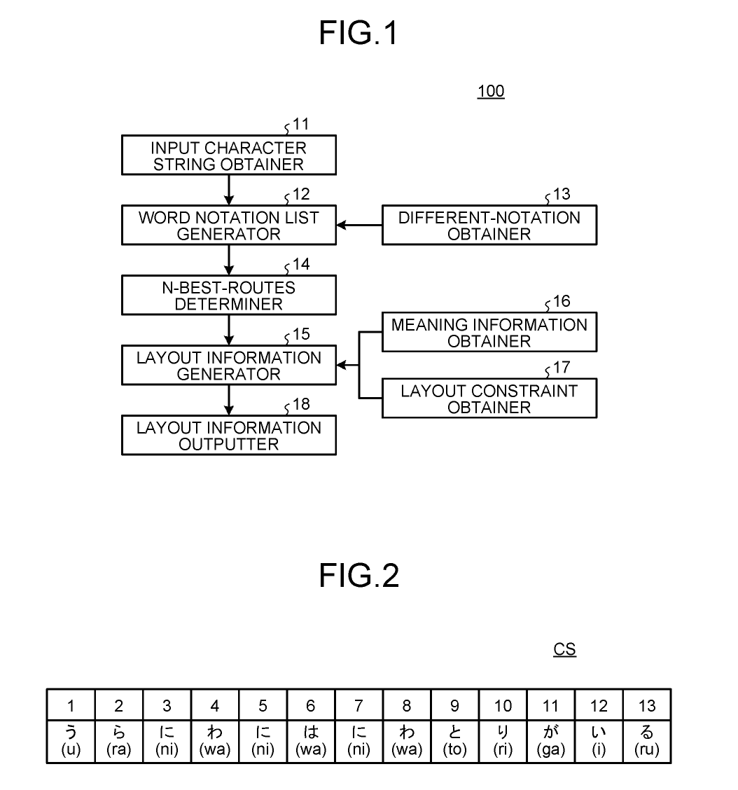

FIG. 1 is a diagram illustrating a functional configuration example of a character input device 100 according to the first embodiment. As illustrated in FIG. 1, the character input device 100 according to the first embodiment includes an input character string obtainer (a first obtainer) 11, a word notation list generator (a second generator) 12, a different-notation obtainer (a second obtainer) 13, and an N-best-routes determiner 14. Moreover, the character input device 100 according to the first embodiment includes a layout information generator (a first generator) 15, a meaning information obtainer (a third obtainer) 16, a layout constraint obtainer (a fourth obtainer) 17, and a layout information outputter 18.

The input character string obtainer 11 according to the first embodiment obtains, as an input character string, a character string input by a user. In the first embodiment, for example, the input character string obtainer 11 obtains, as an input character string, a pre-conversion character string that is input using, for example, a keyboard.

FIG. 2 is a diagram illustrating an example of an input character string CS according to the first embodiment. In FIG. 2 is illustrated an example in which, when a reading “u-ra-ni-wa-ni-wa-ni-wa-to-ri-ga-i-ru” is input, the input character string CS having 13 characters is obtained.

The word notation list generator 12 according to the first embodiment generates a word notation list (word notation information) in which the words of all combinations that can serve as the reading of the input character string CS are held as word notations of notation candidates. Moreover, the word notation list generator 12 counts all character substrings present in the input character string CS. Then, the word notation list generator 12 obtains all different notations with respect to the character substrings (hereinafter, called “different notations”). Subsequently, the word notation list generator 12 generates a word notation list in which information indicating which obtained notation corresponds to which character substring in the input character string is associated to that obtained notation. Herein, in the input character string, the information indicating which obtained notation corresponds to which character substring in the input character string is in the form of numerical values that represent the position of appearance of the character substring to which that obtained notation corresponds. More particularly, the information is numerical values that represent the position of the starting character (hereinafter, called a “start position”) and the position of the ending character (hereinafter, called an “end position”) in the corresponding character substring. Thus, the numerical values indicate which characters in the input character string are at both ends of each obtained notation (i.e., the numerical values indicate the character range of each notation in the input character string). Meanwhile, it is common practice to set a limit of, for example, 16 characters as the length of a character substring.

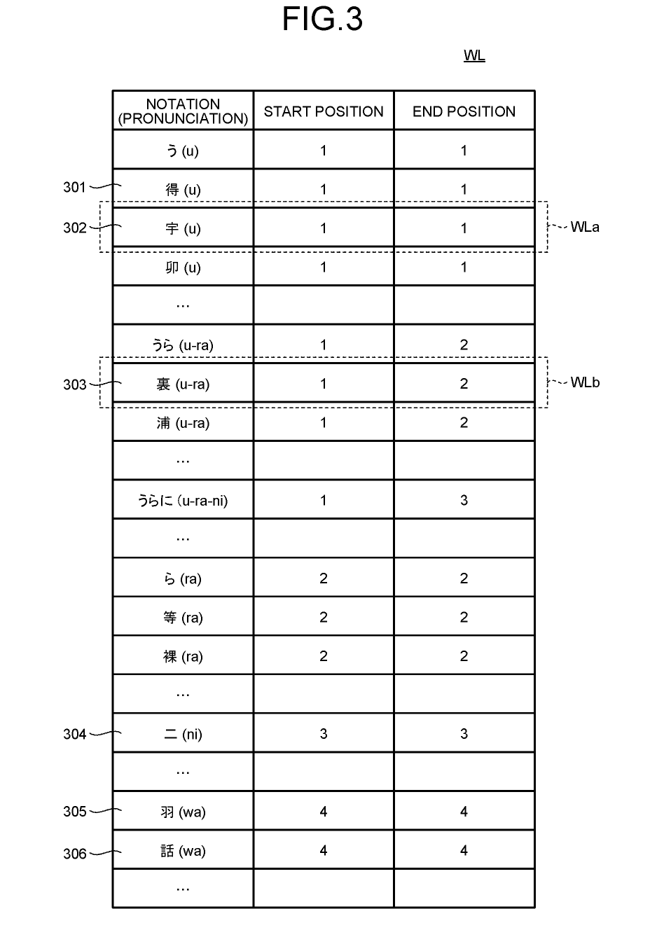

FIG. 3 is a diagram illustrating an example of a word notation list WL according to the first embodiment. In FIG. 3 is illustrated an example of the word notation list WL that is generated in response to the input of the input character string CS illustrated in FIG. 2. In this case, the word notation list generator 12 counts the character substrings as follows: a reading “u”, a reading “u-ra”, a reading “u-ra-ni”, a reading “u-ra-ni-wa”, . . . , a reading “ra”, a reading “ra-ni-wa”, . . . , a reading “ni”, a reading “ni-wa”, a reading “ni-wa-ni”, and so on. In response, in the case of the character substring having the reading “u”, the word notation list generator 12 obtains different notations such as a notation 301, a notation 302, and so on. Similarly, in the case of the character substring having the reading “u-ra”, the word notation list generator 12 obtains different notations such as a notation 303, a notation 304, and so on. The notation 302 obtained herein corresponds to the character substring representing the first character in the input character string. Hence, the information indicating the character substring to which the obtained notation 302 corresponds in the input character string is a numerical value “1” that represents the start position as well as the end position of the corresponding character substring. Similarly, the notation 303 obtained herein corresponds to the character substring starting from the first character and ending at the second character in the input character string. Hence, the information indicating the character substring to which the obtained notation 303 corresponds in the input character string are a numerical value “1” representing the start position of the corresponding character substring and a numerical value “2” representing the end position of the corresponding character substring. Accordingly, as illustrated in FIG. 3, the word notation list generator 12 generates a word notation list WLa in which the notation 302 is associated to the start position “1” and the end position “1”. Similarly, the word notation list generator 12 generates a word notation list WLb in which the notation 303 is associated to the start position “1” and the end position “2”.

The different-notation obtainer 13 obtains different notations with respect to a character substring. The different-notation obtainer 13 obtains all different notations with respect to a character substring specified by the word notation list generator 12. For that purpose, the different-notation obtainer 13 accesses a database (DB) in which the group of supposed different notations with respect to the reading is registered in advance; searches the DB for the reading of a character substring; and obtains, as the search result, the different notations registered for that character substring. Then, the different-notation obtainer 13 sends the obtained different notations to the word notation list generator 12. As a result, the word notation list generator 12 can obtain all different notations with respect to the concerned character substring.

The N-best-routes determiner 14 according to the first embodiment determines, as N number of best routes, N number of (a plurality of) relations of connection (hereinafter, called “routes”) each of which has a high likelihood (a high probability) of serving as the user-intended notation candidate. Herein, the N-best-routes determiner 14 determines the routes from the inference result about the user-intended word notations with respect to the input character string CS and the inference result about the relations of connection (combinations) between the word notations. Each determined route is represented using a word notation string and using numerical values indicating the positions of the word notations in the input character string.

Meanwhile, the N-best-routes determiner 14 treats the word notation list WL, which is generated by the word notation list generator 12, as a directed acyclic graph (DAG: a directed graph not having a closed route). In order to treat the word notation list WL as a directed acyclic graph (i.e., in order to make a graph out of the word notation list WL), the N-best-routes determiner 14 performs the following operations.

Herein, for example, with respect to a word ending at the k-th character, a word notation which can be placed next to that word represents a word notation starting from the k+1-th character. The word notation list WL includes numerical values indicating which characters in the input character string are at both ends of each word notation. Hence, at each character boundary, it becomes possible to count the combinations between all word notations.

Thus, for example, in the reading “u-ra-ni-wa-ni-wa-ni-wa-to-ri-ga-i-ru”, with respect to the character boundary between the third character and the fourth character, the combinations of character substrings can be counted as follows: the reading “ni” and the reading “wa”; the reading “ra-ni” and the reading “wa”; the reading “u-ra-ni” and the reading “wa”; the reading “ni” and the reading “wa-ni”; the reading “ni” and the reading “wa-ni-wa”, . . . , the reading “ra-ni” and the reading “wa-ni”; the reading “ra-ni” and the reading “wa-ni-wa”; and so on. As a result, if each character substring is treated as the reading of a word, then the combinations of all of the different notations can be counted as follows: the notation 304 and a notation 305; the notation 304 and a notation 306; and so on.

The N-best-routes determiner 14 performs such operations with respect to the combinations between all word notations at each boundary, and connects the word notations together in the direction in which the respective character ranges go on increasing. As a result, the N-best-routes determiner 14 obtains a directed acyclic graph G in which the word notations serve as nodes and the connections among the word notations serve as edges. Thus, the N-best-routes determiner 14 infers the user-intended word notations with respect to the input character string CS and infers the relations of connection between the word notations.

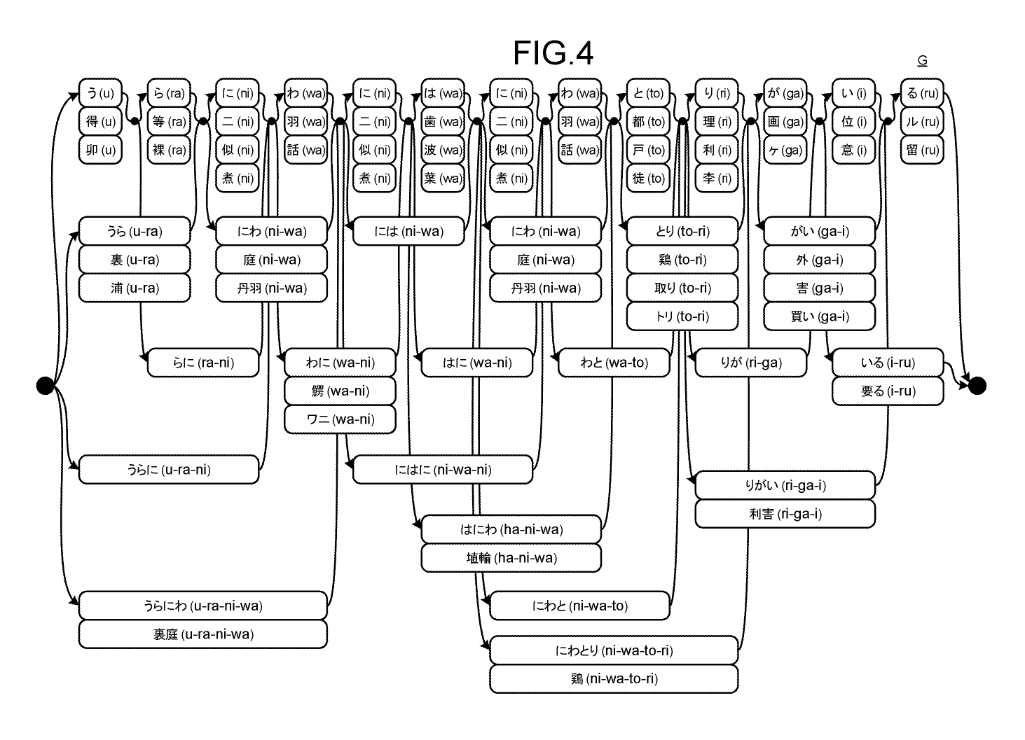

FIG. 4 is a diagram illustrating an example of the directed acyclic graph G according to the first embodiment. In the example illustrated in FIG. 4, the directed acyclic graph G is obtained by performing the abovementioned operations in response to the input of the input character string CS illustrated in FIG. 2. In this directed acyclic graph G, any route in which the directed acyclic graph G can be tracked from start to end corresponds to a notation candidate of the input character string CS.

Moreover, with respect to the directed acyclic graph G, the N-best-routes determiner 14 performs a predetermined calculation, and accordingly determines N number of routes each of which has a high likelihood (a high probability) of serving as the user-intended notation candidate. As far as the calculation performed herein (i.e., the calculation of the routes having a high probability) is concerned; a method is known in which, for example, the Viterbi algorithm is implemented with respect to the directed acyclic graph G by providing the probabilities of appearance of the words as node scores and providing the relations of connections among the words as edge scores (for example, the calculation method written in “The Art of Japanese Input Method”, p. 132˜p. 133, Hiroyuki Tokunaga, Gijutsu-Hyohron Co. Ltd.). Herein, it is assumed that the probabilities of appearance of the words that are provided as the node scores and the relations of connections among the words that are provided as the edge scores are registered in advance in, for example, a DB. Thus, the N-best-routes determiner 14 can access the DB to obtain the probabilities of appearance of the words and the relations of connections among the words, and can assign the node scores and the edges scores during the calculation. Moreover, if the Viterbi algorithm is implemented during the calculation, then the N-best-routes determiner 14 stores, for the top N number of routes, the score up to each node and the adjacent node which provides that score. As a result, the obtained routes can be easily expanded as the top N number of routes. In this way, according to the combinations inferred from the reading of the input character string CS, the N-best-routes determiner 14 connects the word notations of the word notation list WL, and treats a single word notation string formed by connecting the word notations as one of the routes representing a relation of connection. Herein, the N-best-routes determiner 14 determines a plurality of such routes in descending order of the likelihood of serving as the user-intended notation candidates.

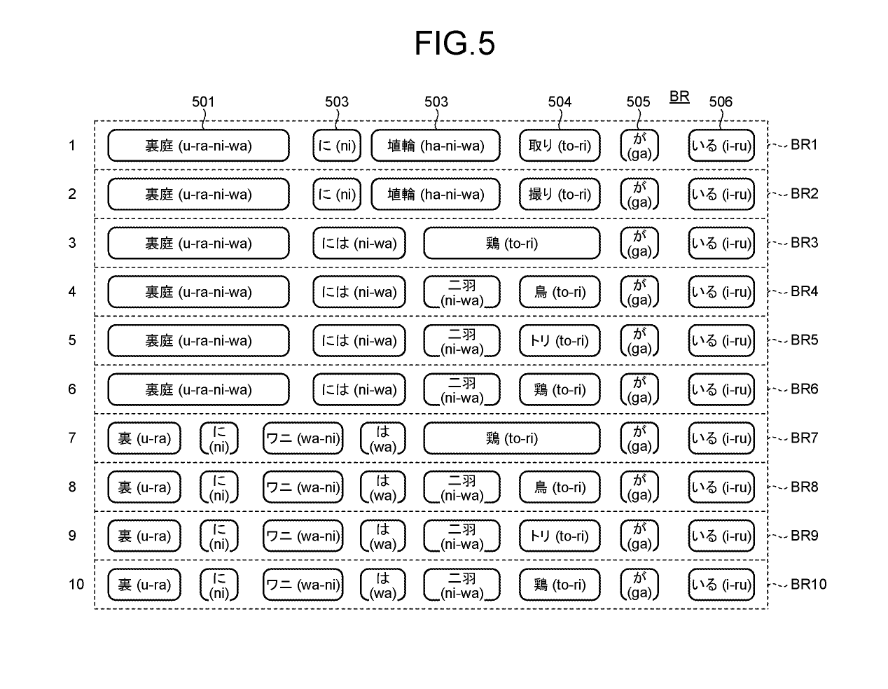

FIG. 5 is a diagram illustrating an example of N number of best routes BR according to the first embodiment. In FIG. 5 is illustrated an example in which the N number of best routes BR are determined by implementing the abovementioned calculation method in response to the input of the input character string CS illustrated in FIG. 2. Thus, in the first embodiment, based on the calculation result obtained from the input character string CS with respect to the directed acyclic graph G, ten routes from a route BR1 to a route BR10 are determined as the N number of best routes BR in descending order of the likelihood of serving as the user-intended notation candidate. Of the N number of best routes BR; for example, the first-ranked route BR1 represents a word notation string that includes six words, namely, a notation 501, a notation 502, a notation 503, a notation 504, a notation 505, and a notation 506. From among those words, the notation 503 corresponds to a character substring from the sixth character to the eighth character in the input character string.

Meanwhile, till now, the explanation is given about the word notation list generator 12 and the N-best-routes determiner 14. Regarding the detailed operations performed by those functional units, it is possible to refer to the description given in “The Art of Japanese Input Method”, Hiroyuki Tokunaga, Gijutsu-Hyohron Co. Ltd.

The layout information generator 15 according to the first embodiment generates, from the N number of best routes BR, layout information that is used for the purpose of displaying the notation candidates. For example, if all of the N number of routes determined by the N-best-routes determiner 14 are displayed, then a large number of characters are displayed as the notation candidates. Because of that, it becomes difficult for the user to find the intended notation in one glace. In that regard, in the first embodiment, firstly, the word notation string of the first-ranked route BR1, which has the highest likelihood of serving as the user-intended notation candidates, is displayed. Subsequently, from the group of word notations included in the remaining nine routes (i.e., N−1 number of routes) starting from the route BR2 to the route BR10 (i.e., the routes other than the first-ranked route), the word notations to be displayed are extracted and displayed. As a result, in the character input device 100 according to the first embodiment, in the case of displaying the notation candidates, the number of characters and the display area can be held down to a range that is not too big with respect to the intended character string.

For that reason, firstly, from the group of word notations included in the nine routes from the route BR2 to the route BR10, the layout information generator 15 extracts the word notations to be displayed. Herein, the layout information generator 15 performs the extraction according to the method given below. The layout information generator 15 sequentially refers to the routes BR2 to BR10 that are to be extracted; and, from the group of word notations included in the routes, sequentially retrieves the notations corresponding to the character substrings present in the input character string CS. Then, the layout information generator 15 determines the word class of the retrieved notations. If a word class indicates a postpositional particle or an auxiliary verb (i.e., an unnecessary word class), then the layout information generator 15 treats that word class as a notation which need not be extracted. That is, the layout information generator 15 identifies notations having predetermined word classes as the notations not to be displayed as the display notations.

Moreover, from the routes BR2 to BR10 that are to be extracted, the layout information generator 15 obtains meaning information of the notations retrieved from the group of word notations of different routes and calculates distances, each of which represents the closeness in the meaning of (the semantic distance between) two notations. Regarding the notations that are close in distance (close in meaning), the layout information generator 15 treats the notation included in the route having a relatively low likelihood of serving as the notation candidate as the notation which need not be extracted. That is, according to the result of distance calculation, if there are notations that have the same meaning or if there are notations that are close in meaning; then the layout information generator 15 identifies, from those notations, the notation which is included in the route having a low likelihood of serving as the user-intended notation candidates as the notation which is not to be displayed as the notation candidates. Meanwhile, regarding the calculation of the distance representing the closeness of meaning between two notations; for example, the meaning representation based on ontology and the method of calculating the meaning representation (such as the calculation method disclosed in JP-A 2010-55505 (KOKAI)) is known. Alternatively, the meaning of words can be represented using coordinates in a feature quantity vector space, and the distance can be calculated as the spatial distance between two points.

In this way, from all word notations included in the routes BR2 to BR10 that are to be extracted, the layout information generator 15 deletes the notations that are determined to be unnecessary for extraction based on the abovementioned conditions. That is, from the group of word notations included in the routes BR2 to BR10 that are to be extracted, the layout information generator 15 identifies the word notations that are not to be displayed (not to be output) as the notation candidates, and deletes the identified word notations. With that, the layout information generator 15 extracts the word notations to be displayed (to be output). Moreover, the layout information generator 15 holds the notations (words) extracted in the manner described above, and generates a display word list (display word information).

As a result, the layout information generator 15 generates layout information for the purpose of displaying the word notation string of the first-ranked route BR1, which has the highest likelihood of serving as the user-intended notation candidate, as well as displaying the extracted word notations according to the notation candidate presentation environment. At that time, the layout information generator 15 obtains a layout constraint that represents a constraint defined for the layout in the notation candidate presentation environment. Herein, the layout constraint is, for example, a numerical value that indicates the number of lines within which the notation candidates are to be displayed. Thus, if the layout constraint is set to “1”, then it is required to display the notation candidates in one line. Based on the layout constraint, the layout information generator 15 determines the display locations and the display sizes of the characters of the notation candidates on a virtual screen; and generates the layout information for the purpose of displaying the word notations according to the determined value. Moreover, based on the layout constraint, the layout information generator 15 selects, from a plurality of layout formats (output formats), a format that satisfies the layout constraint; and generates the layout information for the purpose of displaying the word notations according to the selection result (according to the selected output format).

The meaning information obtainer 16 according to the first embodiment obtains meaning information of the notations. Herein, the meaning information obtainer 16 according to the first embodiment obtains the meaning information of the notations specified by the layout information generator 15. At that time, for example, the meaning information obtainer 16 accesses the DB in which a group of sets of supposed meaning information for notations is registered in advance; searches the DB with a notation as the search key; and obtains, as the search result, the corresponding meaning information that is registered. Then, the meaning information obtainer 16 sends the meaning information to the layout information generator 15. In this way, the layout information generator 15 becomes able to obtain the meaning information of the notations.

The layout constraint obtainer 17 according to the first embodiment obtains the layout constraint. Herein, the layout constraint obtainer 17 obtains the layout constraint in response to an acquisition request from the layout information generator 15. For example, the layout constraint obtainer 17 obtains a set value of the layout constraint that is set via a graphical user interface (GUI). Then, the layout constraint obtainer 17 sends the layout constraint to the layout information generator 15. In this way, the layout information generator 15 becomes able to obtain the layout constraint.

The layout information outputter 18 according to the first embodiment outputs the layout information. Herein, the layout information outputter 18 outputs the layout information, which is generated by the layout information generator 15, to a display device (not illustrated) such as a display. As a result, the notation candidates with respect to the input character string CS are displayed on the display. Alternatively, for example, the layout information outputter 18 can convert the layout information into a data format executable in software for implementing a display function, and can output the converted data. For example, when a Web browser serves as the software for implementing the display function, the layout information outputter 18 can convert the layout information into HTML data (HTML stands for HyperText Markup Language) and can output the converted data on the Web browser.

Details

Given below is the explanation of the detailed operations (coordinated operations of the functional units) of the character input device 100 according to the first embodiment.

Operations During Character Input

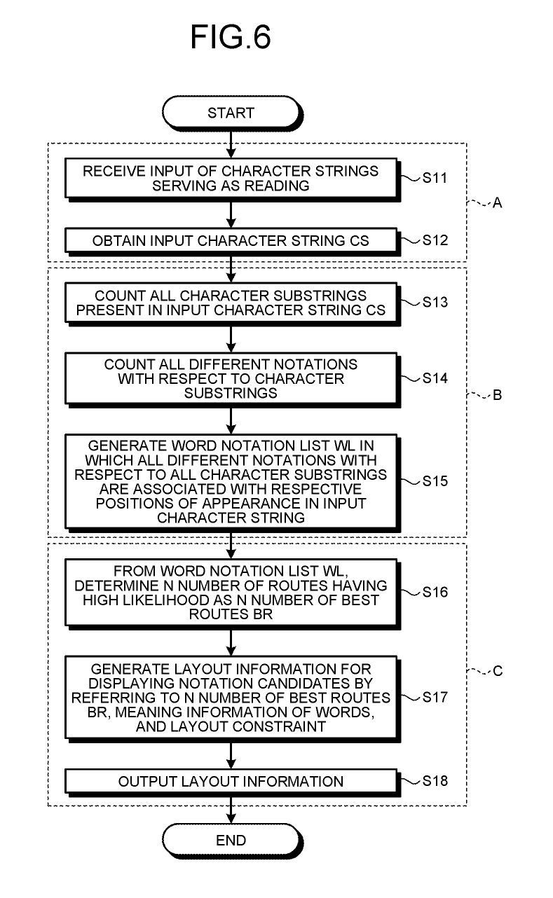

FIG. 6 is a flowchart for explaining an example of the operations performed during an input of characters according to the first embodiment. In FIG. 6 is illustrated an example of the operations performed in the character input device 100 according to the first embodiment in the case when a computer program for implementing the abovementioned character input function is executed during an input of characters. Herein, the operations according to the first embodiment are mainly divided into three types of operations. More particularly, the operations are mainly divided into an operation A for inputting characters (hereinafter, called an “operation A”), an operation B for generating the word notation list WL (hereinafter, called an “operation B”), and an operation C for determining the N number of best routes BR and generating the layout information (hereinafter, called an “operation C”).

As illustrated in FIG. 6, firstly, the character input device 100 according to the first embodiment performs the operation A. More particularly, the character input device 100 receives, from a user, an input of characters that represent the reading (Step S11).

In response, the input character string obtainer 11 according to the first embodiment obtains the input character string CS from the user input (Step S12). Till this stage, the operations correspond to the operation A.

Then, the character input device 100 performs the operation B. More particularly, the word notation list generator 12 according to the first embodiment counts all character substrings present in the input character string CS (Step S13).

Subsequently, the word notation list generator 12 counts all different notations with respect to the character substrings which have been counted (Step S14). Herein, the word notation list generator 12 obtains all different notations with respect to the character substrings using the different-notation obtainer 13, and counts the different notations.

As a result, the word notation list generator 12 generates the word notation list WL in which all different notations of all character substrings are associated with the respective positions of appearance in the input character string (Step S15). At that time, in the input character string, the word notation list generator 12 associates numerical values, which indicate the positions of appearance of the character substrings to which the notations correspond (i.e., numerical values indicating the start positions and the end positions of the character substrings), with the obtained notations. Till this stage, the operations correspond to the operation B.

Then, the character input device 100 performs the operation C. More particularly, the N-best-routes determiner 14 according to the first embodiment determines, as the N number of best routes BR, such N number of routes specified in the word notation list WL which have a high likelihood of serving as the user-intended notation candidates (Step S16). Herein, the N-best-routes determiner 14 treats the word notation list WL as a directed acyclic graph structure, and determines the routes from the inference result about the user-intended word notations with respect to the input character string CS and the inference result about the relations of connection (combinations) between the word notations. Firstly, based on the numerical values representing the positions of appearance in the input character string of the word notations specified in the word notation list WL; the N-best-routes determiner 14 counts the combinations between all word notations at each character boundary. Then, the N-best-routes determiner 14 connects the word notations together in the direction in which the respective character ranges go on increasing. As a result, the N-best-routes determiner 14 obtains the directed acyclic graph G in which the word notations serve as nodes and the connections among the word notations serve as edges, and infers the relations of connection between the word notations. Subsequently, with respect to the directed acyclic graph G, the N-best-routes determiner 14 performs a predetermined calculation; and accordingly determines, as the N number of best routes BR, N number of routes each of which has a high likelihood (a high probability) of serving as the user-intended notation candidate.

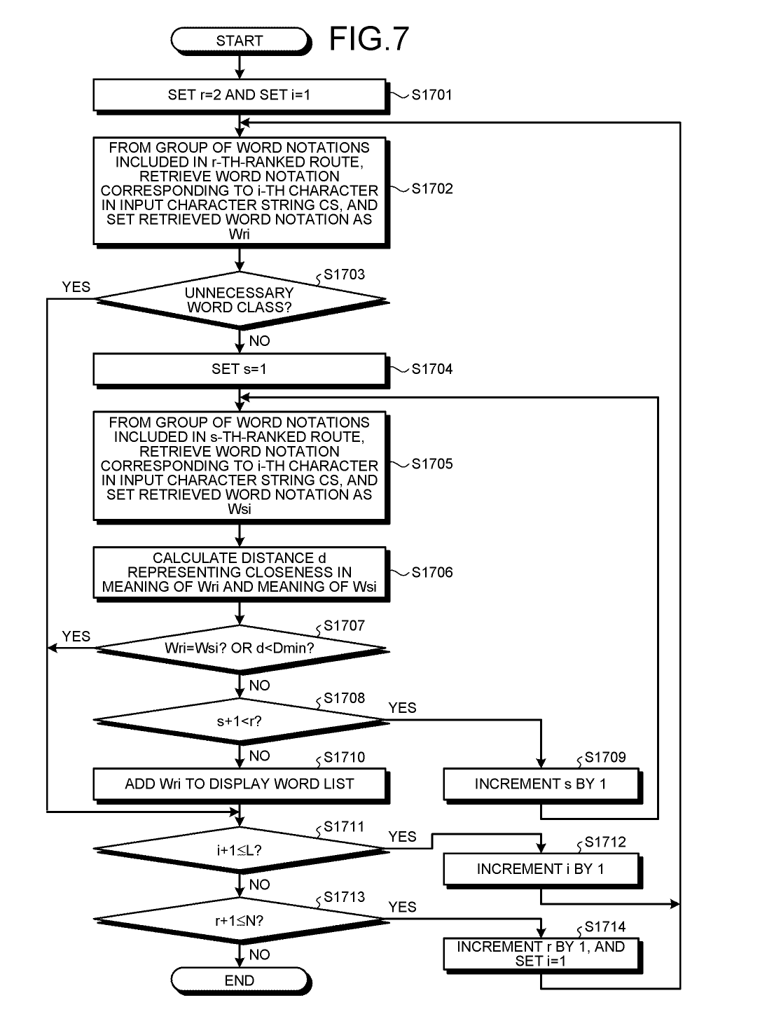

Then, the layout information generator 15 according to the first embodiment generates the layout information, which is used for the purpose of displaying the notation candidates, by referring to the N number of best routes BR, the meaning information of the words, and the layout constraint Step S17). At that time, from the group of word notations included in the nine routes, starting from the route BR2 to the route BR10, other than the first-ranked route; the layout information generator 15 extracts and holds the word notations to be displayed and generates a display word list. Moreover, the layout information generator 15 obtains the meaning information of the notations using the meaning information obtainer 16; calculates distances, each of which represents the closeness in the meaning of two notations, based on the meaning information; and, regarding the notations that are close in distance, extracts the notation included in the route having a relatively high likelihood of serving as the user-intended notation candidate. Meanwhile, the word extraction operation performed at Step S17 is described later with reference to FIG. 7. As a result, the layout information generator 15 generates the layout information for the purpose of displaying the word notation string of the first-ranked route BR1, which has the highest likelihood of serving as the user-intended notation candidates, as well as displaying the extracted word notations according to the notation candidate presentation environment. At that time, the layout information generator 15 obtains a layout constraint for the notation candidate presentation environment using the layout constraint obtainer 17; and, based on the layout constraints, determines the display locations and the display sizes of the characters of the notation candidates on the screen. According to that determined value; the layout information generator 15 generates the layout information for the purpose of displaying the word notations.

Subsequently, the layout information outputter 18 according to the first embodiment outputs the layout information (Step S18). At that time, for example, the layout information outputter 18 transfers the layout information to a display device connected to the character input device 100, and issues a display instruction. In response, on the display device and in a format compatible to the layout constraint, word notations are displayed as the notation candidates with respect to the input character string CS. Till this stage, the operations correspond to the operation C.

Operations During Word Extraction

FIG. 7 is a flowchart for explaining an example of the operations performed during extraction of words according to the first embodiment. In FIG. 7 is illustrated an example of the operation performed by the layout information generator 15 at Step S17 mentioned above. In the example of the operations explained below, it is assumed that the input character string CS having 13 characters as illustrated in FIG. 2 is obtained, and that 10 routes from the routes BR1 to BR10 are determined as the N number of best routes BR with respect to the input character string CS.

The layout information generator 15 according to the first embodiment sets a variable r to 2 and sets a variable i to 1 (Step S1701). Herein, the variable r represents a route determined as one of the N number of best routes BR, while the variable i represents a character position in the input character string CS. Thus, at Step S1701, setting the variable r to the initial value of 2 implies that the nine routes starting from the routes BR2 to BR10 other than the first-ranked route, which has the highest likelihood of serving as the user-intended notation candidate, are treated as the target routes for extraction and are sequentially referred to in the subsequent operations. Moreover, at Step S1701, setting the variable i to the initial value of 1 implies that the characters in the input character string are sequentially referred to starting from the first character.

Then, the layout information generator 15 retrieves, from the group of word notations included in the r-th-ranked route, the word notation corresponding to the i-th character in the input character string CS; and sets the retrieved word notation as Wri (Step S1702). Herein, “sets as Wri” means assigning the retrieved word notation to a variable Wri.

Subsequently, the layout information generator 15 determines whether the word class of Wri is an unnecessary word class (such as a postpositional particle or an auxiliary verb) (Step S1703). Based on the result of the determination, the layout information generator 15 determines that such Wri which is determined to be unnecessary is a word notation which need not be extracted. That is, such Wri which fits in the determination condition is not treated as the word notation to be displayed (i.e., not treated as the notation candidate to be displayed).

Thus, when the word class of Wri is an unnecessary word class (YES at Step S1703), the layout information generator 15 does not perform the operations at Step S1704 to Step S1710. Then, the system control proceeds to Step S1711.

On the other hand, when the word class of Wri is not an unnecessary word class (NO at Step S1703), the layout information generator 15 sets a variable s to 1 (Step S1704). Herein, the variable s represents a route determined as one of the N number of best routes BR. At Step S1704, setting the variable s to 1 implies that the routes at an upper level than the r-th-ranked route are sequentially referred to from among the N number of best routes BR in the subsequent operations.

Then, from the group of word notations included in the s-th-ranked route, the layout information generator 15 retrieves the word notation corresponding to the i-th character in the input string CS, and sets the retrieved word notation as Wsi (Step S1705). Herein, “sets as Wsi” means assigning the retrieved word notation to a variable Wsi.

Then, the layout information generator 15 calculates a distance d that represents the closeness in the meaning of Wri and the meaning of Wsi (Step S1706). At that time, the layout information generator 15 obtains the meaning information of Wri and the meaning information of Wsi using the meaning information obtainer 16. That is, the layout information generator 15 obtains the meaning information of the word notations retrieved from the group of word notations included in the r-th-ranked route, and obtains the meaning information of the word notations retrieved from the group of word notations included in the s-th-ranked route. Herein, it is assumed that the meaning of words is represented using coordinates in a feature quantity vector space, and the distance d is calculated as the spatial distance between two points. Hence, as the distance in the feature vector space, it is assumed that a scalar value d is obtained.

Then, based on the calculation result of the distance d, the layout information generator 15 determines whether Wri and Wsi point to the same notation or whether the distance d is smaller than a threshold value Dmin (Step S1707). Herein, the threshold value Dmin corresponds to the minimum distance representing the closeness in the meaning of notations (i.e., corresponds to a reference value for determining that the meaning is close), and is set in advance. Based on this determination, the layout information generator 15 determines that such Wri which is either same as or close in meaning to Wsi included in the upper level routes than the r-th-ranked route r is a word notation that need not be extracted. That is, such Wri which corresponds to this determination condition is not treated as the word notation to be displayed.

Thus, based on the calculation result of the distance d, if Wri and Wsi point to the same notation or if the distance d is smaller than the threshold value Dmin (YES at Step S1707), then the layout information generator 15 does not perform the operations from Step S1708 to Step S1710. Then, the system control proceeds to Step S1711.

If Wri and Wsi do not point to the same notation and if the distance d is equal to or greater than the threshold value Dmin (NO at Step S1707); then the layout information generator 15 determines whether the value (s+1), which is obtained by incrementing the variable s by 1, is smaller than the value of the variable r (Step S1708).

If the value (s+1) is smaller than the value of the variable r (YES at Step S1708), then the layout information generator 15 increments the variable s by 1 (Step S1709). The system control then returns to Step S1705. With that, with respect to the routes at an upper level than the r-th-ranked route, the layout information generator 15 performs the abovementioned determination based on the distance d between the word notations that have been retrieved, and checks for the word notations that need not be extracted.

On the other hand, if the value (s+1) is equal to or greater than the variable r (NO at Step S1708), then the layout information generator 15 adds Wri to the display word list in response to the fact that checking for such Wri which need not be extracted is completed with respect to the routes at an upper level than the r-th-ranked route (Step S1710). With that, the layout information generator 15 extracts, as a word notation to be displayed, the word notation assigned to the variable Wri.

Then, the layout information generator 15 determines whether the value (i+1), which is obtained by incrementing the variable i by 1, is equal to or smaller than a variable L (Step S1711). Herein, the variable L corresponds to a value representing the number of characters in the input character string CS. Thus, in the first embodiment, the variable L is equal to 13.

If the value (i+1) is equal to or smaller than the value of the variable L (YES at Step S1711), then the layout information generator 15 increments the variable i by 1 (Step S1712). Then, the system control returns to Step S1702. As a result, from the group of word notations included in the r-th-ranked route, the layout information generator 15 retrieves the word notation corresponding to the i+1-th character in the input character string CS; checks whether that word notation need not be extracted; and extracts the word notation if it is to be displayed.

On the other hand, if the value (i+1) is greater than the value of the variable r (NO at Step S1711), then the system control proceeds to Step S1713 in response to the fact that, with respect to all characters in the input character string CS, the respective word notations have been retrieved from the group of word notations included in the r-th-ranked route.

Then, the layout information generator 15 determines whether or not the value (r+1), which is obtained by incrementing the variable r by 1, is equal to or smaller than a variable N (Step S1713). Herein, the variable N represents a value indicating the number of routes determined as the N number of best routes BR. Thus, in the first embodiment, the variable N is equal to 10.

If the value (r+1) is equal to or smaller than the variable N (YES at Step S1713), then the layout information generator 15 increments the variable r by 1 and sets the variable i to 1 (Step S1714). Then, the system control returns to Step S1702. Thus, from the group of word notations included in the r+1-th-ranked route, the layout information generator 15 retrieves the word notation corresponding to the i-th character in the input character string CS; and checks whether that word notation need not be extracted.

On the other hand, if the value (r+1) is greater than the value of the variable N (NO at Step S1713), then the layout information generator 15 checks, with respect to the nine routes BR2 to BR10 that are to be extracted, for the word notations that need not be extracted and ends the operations in response to the fact that the word notations to be displayed have been extracted.

Result of Word Extraction

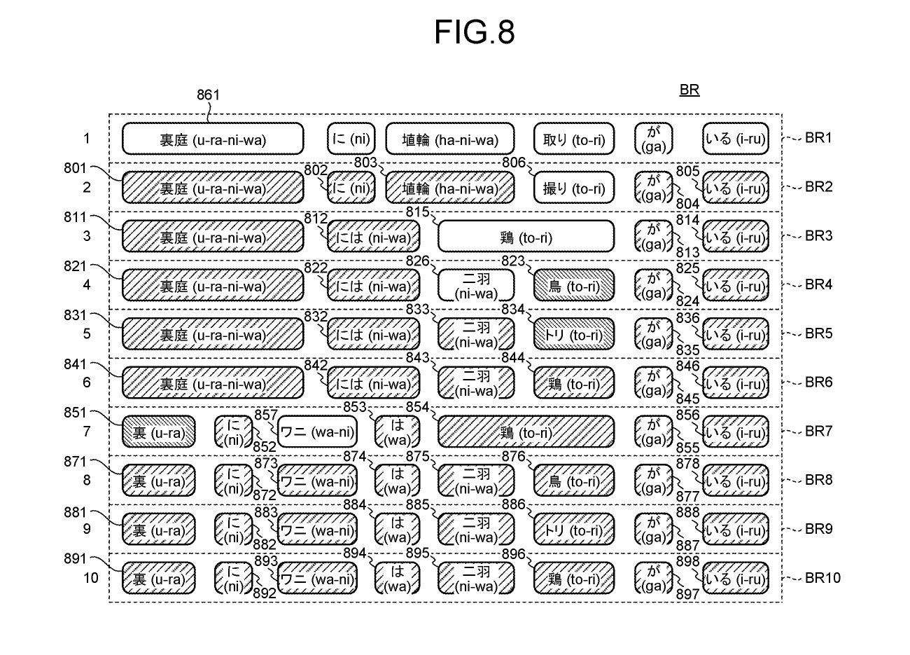

FIG. 8 is a diagram illustrating an example of the result of word extraction according to the first embodiment. In FIG. 8 is illustrated an example of the result of extracting the word notations to be displayed from the group of word notations that are included in the target routes BR2 to BR10 for extraction from among the N number of best routes BR by performing the operations explained with reference to FIG. 7. Regarding the first-ranked route BR1, since it corresponds to the route having the highest likelihood of serving as the user-intended notation candidate, it is not considered a target route for extraction.

In FIG. 8, the word notations displayed in a hatched manner correspond to the word notations that are not extracted as the word notations to be displayed during the operations explained with reference to FIG. 7 (i.e., correspond to the word notations that are not displayed as the notation candidates). More particularly, the explanation is given below.

In the second-ranked route BR2, a notation 802 and a notation 804 are unnecessary word classes. Hence, those notations fall under the category of un-extracted word notations. Moreover, in the second-ranked route BR2; a notation 801, a notation 803, and a notation 805 are notations identical to the notations present in the group of word notations included in the upper level route BR1. Hence, those notations fall under the category of un-extracted word notations.

In the third-ranked route BR3, a notation 812 and a notation 813 are unnecessary word classes. Hence, those notations fall under the category of un-extracted word notations. Moreover, in the second-ranked route BR2, a notation 811 and a notation 814 are notations identical to the notations present in the group of word notations included in the upper level routes BR1 and BR2. Hence, those notations fall under the category of un-extracted word notations.

In the fourth-ranked route BR4, a notation 822 and a notation 824 are unnecessary word classes. Hence, those notations fall under the category of un-extracted word notations. Moreover, in the fourth-ranked route BR4, a notation 821 and a notation 825 are notations identical to the notations present in the group of word notations included in the upper level route BR1. Hence, those notations fall under the category of un-extracted word notations. Furthermore, in the fourth-ranked route BR4, a notation 823 is close in meaning to a notation 815 present in the group of word notations included in the upper level route BR3. Hence, the notation 823 falls under the category of un-extracted word notations.

In the fifth-ranked route BR5, a notation 832 and a notation 835 are unnecessary word classes. Hence, those notations fall under the category of un-extracted word notations. Moreover, in the fifth-ranked route BR5; a notation 831, a notation 833, and a notation 836 are notations identical to the notations present in the group of word notations included in the upper level routes BR1 and BR4. Hence, those notations fall under the category of un-extracted word notations. Furthermore, in the fifth-ranked route BR5, a notation 834 is close in meaning to the notation 815 present in the group of word notations included in the upper level route BR3. Hence, the notation 834 falls under the category of un-extracted word notations.

In the sixth-ranked route BR6, a notation 842 and a notation 845 are unnecessary word classes. Hence, those notations fall under the category of un-extracted word notations. Moreover, in the sixth-ranked route BR6; a notation 841, a notation 843, a notation 844, and a notation 846 are notations identical to the notations present in the group of word notations included in the upper level routes BR1, BR3, and BR4. Hence, those notations fall under the category of un-extracted word notations.

In the seventh-ranked route BR7, a notation 852, a notation 853, and a notation 855 are unnecessary word classes. Hence, those notations fall under the category of un-extracted word notations. Moreover, in the seventh-ranked route BR7; a notation 854 and a notation 856 are notations identical to the notations present in the group of word notations included in the upper level routes BR1 and BR3. Hence, those notations fall under the category of un-extracted word notations. Furthermore, in the seventh-ranked route BR7, a notation 851 is close in meaning to a notation 861 present in the group of word notations included in the upper level route BR1. Hence, the notation 851 falls under the category of un-extracted word notations.

In the eighth-ranked route BR8, a notation 872, a notation 874, and a notation 877 are unnecessary word classes. Hence, those notations fall under the category of un-extracted word notations. Moreover, in the eighth-ranked route BR8; a notation 871, a notation 873, a notation 875, a notation 876, and a notation 878 are notations identical to the notations present in the group of word notations included in the upper level routes BR1, BR4, and BR7. Hence, those notations fall under the category of un-extracted word notations.

In the ninth-ranked route BR9, a notation 882, a notation 884, and a notation 887 are unnecessary word classes. Hence, those notations fall under the category of un-extracted word notations. Moreover, in the ninth-ranked route BR9; a notation 881, a notation 883, a notation 885, a notation 886, and a notation 888 are notations identical to the notations present in the group of word notations included in the upper level routes BR1, BR4, BR5, and BR7. Hence, those notations fall under the category of un-extracted word notations.

In the 10-th-ranked route BR10, a notation 892, a notation 894, and a notation 897 are unnecessary word classes. Hence, those notations fall under the category of un-extracted word notations. Moreover, in the 10-th-ranked route BR10; a notation 891, a notation 893, a notation 895, a notation 896, and a notation 898 are notations identical to the notations present in the group of word notations included in the upper level routes BR1, BR3, BR4, and BR7. Hence, those notations fall under the category of un-extracted word notations.

In this way, in the first embodiment, as a result of performing the operations explained with reference to FIG. 7, from the groups of word notations included in the target routes BR2 to BR10 for extraction, a notation 806 included in the second-ranked route BR2 is extracted as a word notation to be displayed; the notation 815 included in the third-ranked route BR3 is extracted as a word notation to be displayed; a notation 826 included in the fourth-ranked route BR4 is extracted as a word notation to be displayed; and a notation 857 included in the seventh-ranked route BR7 is extracted as a word notation to be displayed.

Output Result of Layout Information

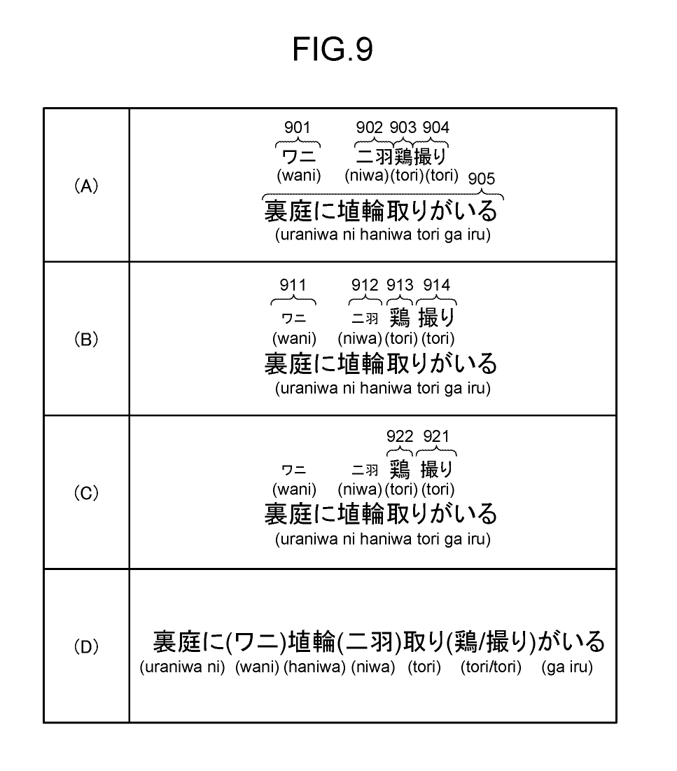

FIG. 9 is a diagram illustrating an output example of the layout information according to the first embodiment. In FIG. 9 is illustrated an example of the result of displaying the layout information on the basis of the word notation extraction result illustrated in FIG. 8.

As illustrated in FIG. 9, the word notation string of the first-ranked route BR1, which has the highest likelihood of serving as the user-intended notation candidate, and the extracted word notations are displayed as the notation candidates on the screen. Herein, examples of the layout format of the extracted word notations include the formats given below. In the first embodiment, four examples of the layout format are given.

In parts (a) to (c) in FIG. 9 are illustrated the examples of the layout formats in which the word notation string of the first-ranked route BR1 and the extracted word notations are displayed in two lines.

More particularly, in part (a) in FIG. 9 is illustrated an example of the layout display in which the characters of the extracted word notations are displayed using a smaller font size than the characters present in the word notation string of the first-ranked route BR1. As compared to a word notation string 905 of the first-ranked route BR1; a notation 901, a notation 902, a notation 903, and a notation 904 of the extracted word notations are displayed using a smaller font size.

In part (b) in FIG. 9 is illustrated an example in which the characters of the word notations extracted from the upper level routes are displayed using a bigger font size than the word notations extracted from the lower level routes. As compared to a notation 911 of the word notation extracted from the seventh-ranked route BR7 and a notation 912 of the word notation extracted from the fourth-ranked route BR4; a notation 913 of the word notation extracted from the third-ranked route BR3 and a notation 914 of the word notation extracted from the second-ranked route BR2 are displayed using a bigger font size.

In part (c) in FIG. 9 is illustrated an example in which, among the extracted word notations, the word notations having a smaller number of characters are displayed using a bigger font size than the word notations having a greater number of characters. As compared to a two-character notation 921 of the word notation extracted from the second-ranked route BR2, a one-character notation 922 of the word notation extracted from the third-ranked route BR3 is displayed in a bigger font size.

In this way, in parts (a) to (c) in FIG. 9 are illustrated examples in which the word notation string of the first-ranked route BR1 is displayed in a different manner than the display of the word notations extracted from the second-ranked route BR2 to the 10-th-ranked route BR10.

In contrast, in part (d) in FIG. 9 is illustrated an example of the layout format in which the word notation string of the first-ranked route BR1 and the extracted word notations are displayed in a single line. In this case, each extracted word notation is displayed in parentheses after a notation, from among the word notations in the first-ranked route BR1, which has the closest position of appearance in the input character string.

In this way, in the first embodiment, based on the layout constraint for the notation candidate presentation environment, a layout format satisfying the layout constraint is selected from the layout formats explained above. Then, according to the selection result, the layout information is output and the word notations are displayed.

Summary

As described above, in the character input device 100 according to the first embodiment, the input character string obtainer 11 receives input of characters from the user and obtains the input character string CS. Then, in the character input device 100, the word notation list generator 12 generates the word notation list WL that includes the words of all combinations which can serve as the reading of the input character string CS. Moreover, in the character input device 100, the N-best-routes determiner 14 treats the word notation list WL as a directed acyclic graph; infers the user-intended word notations and infers the relations of connection (combinations) between the word notations; and determines the N number of best routes BR each of which has a high likelihood (a high probability) of serving as the user-intended notation candidate. Furthermore, in the character input device 100, the layout information generator 15 extracts, from the group of word notations included in the N number of best routes BR, the word notations to be displayed; and generates the layout information that is used for the purpose of outputting the word notation string of the first-ranked route BR1, which has the highest likelihood of serving as the user-intended notation candidates, as well as outputting the extracted word notations as the notation candidates. Subsequently, in the character input device 100, the layout information outputter 18 outputs the layout information.

As a result, in the character input device 100 according to the first embodiment, the word notation string having the highest likelihood of serving as the user-intended notation candidate is displayed along with the word notations to be displayed, and an environment is provided that enables presentation of the notation candidates with respect to the input character string CS. As a result, without making the user perform the operations such as instructing a conversion, selecting the intended notations, and correcting the separation according to phrases or words; the character input device 100 according to the first embodiment can present the user-intended notations automatically as well as at a high probability from the input character string CS. With that, even in a situation in which, for example, the user is listening to a lecture and it is difficult for him or her to constantly look at the screen; the character input device 100 according to the first embodiment can provide a service that enables the user to efficiently carry on with the character input with bare minimum attentiveness. Thus, the character input device 100 according to the first embodiment enables achieving enhancement in the user-friendliness.

### Second Embodiment

### Brief Overview

Consider a case in which, while listening to a person talk during a meeting or a lecture, the user performs character input for the purpose of taking down notes. In such a situation, it is desirable to enable the user to perform character input at a higher speed. In that regard, in a second embodiment, a technology is proposed by which, without having to input the characters of a phrase or a word to the end, it becomes possible to make transition to inputting the next phrase or the next word. As a result, in a character input device according to the second embodiment, it becomes possible to not only achieve the same effect as achieved in the first embodiment, but also provide an environment to the user to perform high-speed character input. The following explanation is given with the focus on the differences with the first embodiment, and the same constituent elements are referred to by the same reference numerals and the explanation thereof is either given only briefly or not repeated at all.

Given below is the explanation about the character input function of the character input device 100 according to the second embodiment. Herein, the character input device 100 according to the second embodiment receives input of characters from a user, and obtains the input character string CS. Then, with respect to the input character string CS, the character input device 100 according to the second embodiment inserts a symbol at a user-specified character position so as to indicate termination in character input. Subsequently, from the input character string CS in which a symbol has been inserted to indicate termination in character input, the character input device 100 according to the second embodiment infers the user-intended word notations and infers the relations of connection (combinations) between word notations, and determines the N number of best routes BR each of which has a high likelihood (a high probability) of serving as the user-intended notation candidate. Then, from the group of word notations included in the N number of best routes BR, the character input device 100 according to the second embodiment extracts the word notations to be displayed. Moreover, the character input device 100 according to the second embodiment generates layout information for the purpose of displaying the word notation string of the first-ranked route BR1, which has the highest likelihood of serving as the user-intended notation candidate (conversion candidate), as well as displaying the extracted word notations as the notation candidates. Then, the character input device 100 according to the second embodiment outputs the generated layout information. These are the functions provided in the character input device 100 according to the second embodiment.

Given below is the explanation of a functional configuration of the character input device 100 according to the second embodiment and the operations performed in the character input device 100. In the second embodiment, the character input device 100 is assumed to be a typical information processing device, and the explanation is given for an example in which the character input device 100 is used to perform a Japanese language input using a keyboard. Moreover, in the second embodiment, it is assumed that a user inputs a character string “ur-ra-ni|ni-wa-to|i-ru”. This is equivalent to an input example in the case in which the user wises to input “ur-ra-ni-wa-ni-wa-ni-wa-to-ri-ga-i-ru” but, without inputting the characters of the phrases or the words to the end, makes transitions to inputting the next phrase or the next word. Herein, in the sentence, “|” corresponds to a symbol indicating termination in character input (hereinafter, as a matter of convenience, called “termination symbol”).

Functional Configuration

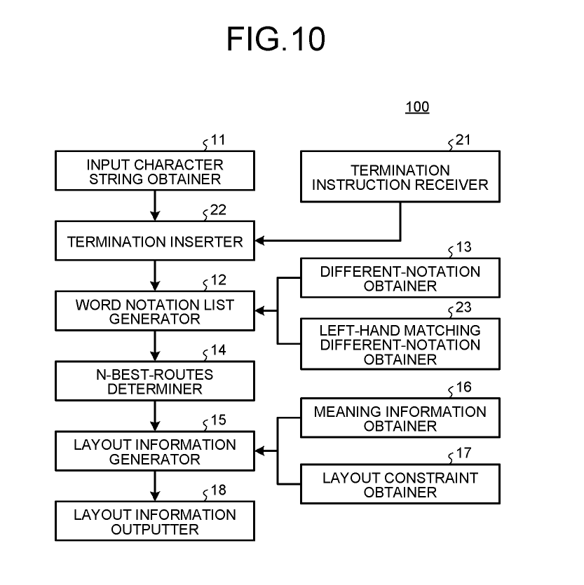

FIG. 10 is a diagram illustrating a functional configuration example of the character input device 100 according to the second embodiment. As illustrated in FIG. 10, in addition to the functional units explained in the first embodiment, the character input device 100 according to the second embodiment further includes a termination instruction receiver 21, a termination inserter 22, and a left-hand matching different-notation obtainer (a fifth obtainer) 23.

The termination instruction receiver 21 according to the second embodiment receives a character input termination instruction from the user. In the second embodiment, when a user wishes to terminate the ongoing input of a phrase or a word and wishes to start inputting the next phrase or the next word; for example, he or she presses a predetermined key of the keyboard. As a result, the termination instruction receiver 21 receives a character input termination instruction. That is, the termination instruction receiver 21 receives an instruction to terminate the character input.

The termination inserter 22 according to the second embodiment inserts the termination symbols in the input character string CS. Herein, the termination inserter 22 according to the second embodiment inserts the termination symbols in the input character string CS at the character positions for termination specified by the user. A termination symbol is equivalent to, for example, an arbitrary byte sequence such as “0x01”. Meanwhile, in the information (in the form a table) in which the character positions of the input character strings CS are recorded, a pointer can be inserted that represents the character position (such as “the third character”) for termination.

The word notation list generator 12 according to the second embodiment generates a word notation list that includes the words of all combinations that can serve as the reading of the input character string CS. Moreover, the word notation list generator 12 counts all character substrings present in the input character string CS. However, in the second embodiment, at the time of counting the character substrings, the characters in the input character string are treated in a different manner than the first embodiment. More particularly, at the time of counting the character substrings, the word notation list generator 12 treats an inserted termination symbol also as a character. Moreover, the word notation list generator 12 sets the range for counting the character substrings to the range not exceeding the termination. Thus, for example, the word notation list generator 12 counts the character substrings “u”, “u-ra”, “u-ra-ni”, and “u-ra-ni|”, but does not count “u-ra-ni|ni”. Moreover, the word notation list generator 12 obtains all different notations for the character substrings. However, in the second embodiment, at the time of obtaining the different notations, the characters in the character substrings are treated in a different manner than the first embodiment. More particularly, from a character substring including the termination symbol (i.e., from a character substring in which the termination symbol is the terminating character), the word notation list generator 12 removes (deletes) the termination symbol and obtains the different notations starting with the post-removal character string (i.e., obtains left-hand matching different notations). Thus, for example, from “u-ra-ni|”, the word notation list generator 12 removes “|” and obtains left-hand matching notations such as the notation 861 illustrated in FIG. 8 (i.e., obtains notations starting with the post-removal character string). Meanwhile, with respect to the character substrings not including the termination symbol, the word notation list generator 12 obtains the different notations in an identical manner to the first embodiment (i.e., using the different-notation obtainer 13).

The left-hand matching different-notation obtainer 23 according to the second embodiment obtains left-hand matching different notations with respect to a character string from which the termination symbol is removed. Herein, the left-hand matching different-notation obtainer 23 according to the second embodiment obtains all left-hand matching different notations with respect to a character string specified by the word notation list generator 12 (i.e., a character string from which the termination symbol is removed). At that time, for example, the left-hand matching different-notation obtainer 23 accesses a DB in which the group of supposed different notations with respect to the reading is registered in advance; searches the DB according to left-hand matching; and obtains the corresponding registered different notations as the search result. As the method for performing a high-speed search of left-hand matching notations from a voluminous group of words; for example, a method for performing a high-speed search using trie data structure is known (for example, the calculation method written in “The Art of Japanese Input Method”, p. 89˜p. 93, Hiroyuki Tokunaga, Gijutsu-Hyohron Co. Ltd.”). Then, the left-hand matching different-notation obtainer 23 sends the different notations obtained in the abovementioned manner to the word notation list generator 12. With that, the word notation list generator 12 becomes able to obtain all left-hand matching different notations with respect to the character string.

Meanwhile, in the second embodiment, the N-best-routes determiner 14, the layout information generator 15, the meaning information obtainer 16, the layout constraint obtainer 17, and the layout information outputter 18 perform identical operations to the first embodiment.

Details

Given below is the explanation of the detailed operations (coordinated operations of the functional units) of the character input device 100 according to the second embodiment.

Operations During Character Input

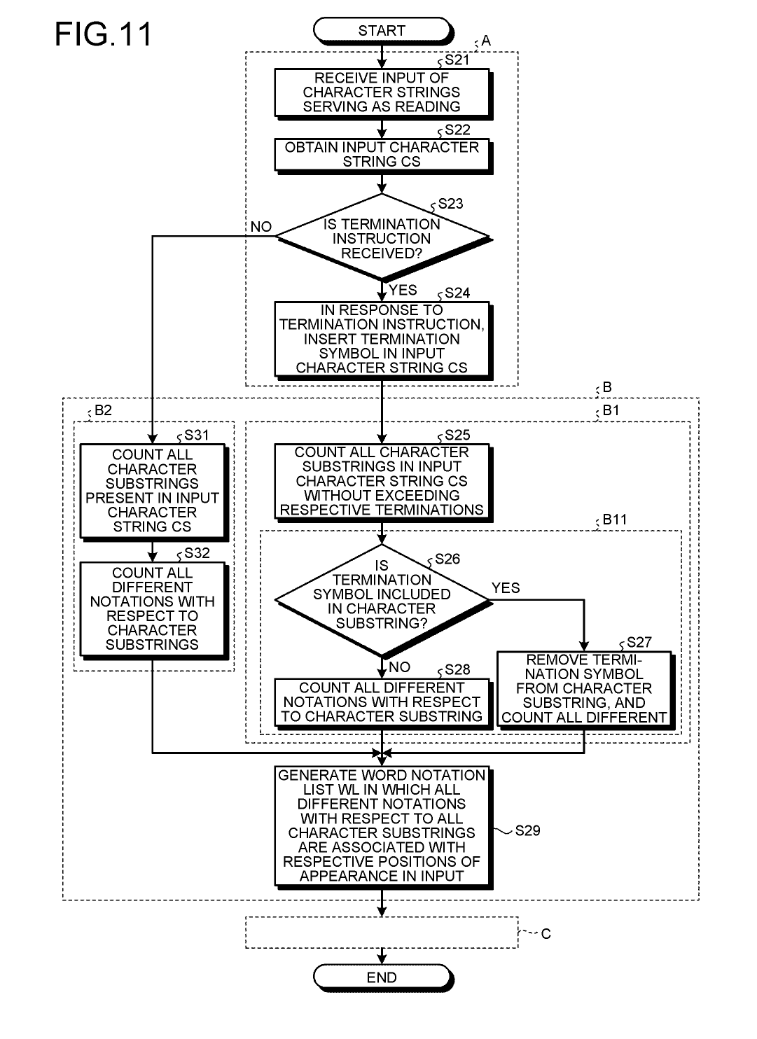

FIG. 11 is a flowchart for explaining an example of the operations performed during an input of characters according to the second embodiment. In FIG. 11 is illustrated an example of the operations performed in the character input device 100 according to the second embodiment in the case when a computer program for implementing the abovementioned character input function is executed during an input of characters. Herein, in an identical manner to the first embodiment, the operations according to the second embodiment are mainly divided into three types of operations. More particularly, the operations are mainly divided into the operation A for inputting characters (hereinafter, called the “operation A”), the operation B for generating the word notation list WL (hereinafter, called the “operation B”), and the operation C for determining the N number of best routes BR and generating the layout information (hereinafter, called the “operation C”). Of those operations, the operations A and B are different than the first embodiment. Hence, the operations A and B are explained below, but the explanation of the operation C is not given.

As illustrated in FIG. 11, firstly, the character input device 100 according to the second embodiment performs the operation A. More particularly, the character input device 100 receives, from a user, an input of characters that represent the reading (Step S21).

In response, the input character string obtainer 11 according to the second embodiment obtains the input character string CS from the user input (Step S22).

Then, the termination instruction receiver 21 determines whether a character input termination instruction is received from the user (Step S23). At that time, for example, based on whether or not a press event of a predetermined key of the keyboard is generated, the termination instruction receiver 21 determines whether the termination instruction is received.

When a character input termination instruction is received (YES at Step S23), the termination instruction receiver 21 notifies the termination inserter 22 about that termination instruction.

According to the termination instruction that is received, the termination inserter 22 according to the second embodiment inserts a termination symbol in the input character string CS (Step S24). Herein, the termination inserter 22 inserts, in the input character string CS, a termination symbol at the user-specified termination character position. Till this stage, the operations correspond to the operation A.

Then, the character input device 100 performs an operation B1. More particularly, the word notation list generator 12 according to the second embodiment counts all character substrings without exceeding the respective terminations (Step S25). At that time, based on one or more termination symbols inserted in the input character string CS, the word notation list generator 12 counts the character substrings in the following manner. Firstly, the word notation list generator 12 counts the character substring representing a first character string starting from the first character in the input character string CS up to a first termination symbol that appears first. Then, the word notation list generator 12 counts the character substring representing a second character string starting from the character next to the first termination symbol up to a second termination symbol appearing second. In this way, the word notation list generator 12 performs counting by setting the range for counting character substrings to the range that does not exceed terminations. Lastly, the word notation list generator 12 counts the character substring representing an n+1-th character string starting from the character next to the n-th termination symbol appearing last up to the character at the end of the input character string CS. As a result, the word notation list generator 12 counts all character substrings in each of a plurality of character strings obtained by dividing the input character string CS by the termination symbols.

Then, the word notation list generator 12 performs an operation B11. Herein, the word notation list generator 12 performs the operation B11 with respect to all character substrings counted in each of a plurality of divided character strings. More particularly, the word notation list generator 12 determines whether termination symbols are included in the counted character substrings (Step S26). At that time, the word notation list generator 12 refers to the terminating character of a character substring and, based on whether or not that character is a termination symbol, determines whether the termination symbol is included.

When the termination symbol is included in a character substring (YES at Step S26), the word notation list generator 12 removes the termination symbol from the character substring and counts all different notations starting with the post-removal character string (i.e., left-hand matching different notations) (Step S27). At that time, the word notation list generator 12 obtains, via the left-hand matching different-notation obtainer 23, all left-hand matching different notations with respect to the character string from which the termination symbol has been removed; and counts the different notations that are obtained.

Meanwhile, on the other hand, if the termination symbol is not included in a character substring (NO at Step S26), then the word notation list generator 12 counts all different notations of that character substring (Step S28). At that time, the word notation list generator 12 obtains, via the left-hand matching different-notation obtainer 23, all different notations with respect to the character substring and counts those different notations. Till this stage, the operations correspond to the operation B11 and the operation B1.

Meanwhile, in the character input device 100, if a character input termination instruction is not received (NO at Step S23), then an operation B2 is performed. More particularly, the word notation list generator 12 according to the second embodiment counts all character substrings present in the input character string CS (Step S31) and counts all different notations with respect to the counted character substrings (Step S32). Till this stage, the operations correspond to the operation B2. Thus, the operation B2 corresponds to the operations performed at Steps S13 and S14 explained with reference to FIG. 6 in the first embodiment.

As a result, the word notation list generator 12 generates the word notation list WL in which all different notations of all character strings are associated with the respective positions of appearance in the input character string (Step S29). At that time, in the input character string, the word notation list generator 12 associates numerical values, which indicate the positions of appearance of the character substrings to which the notations correspond (i.e., numerical values indicating the start positions and the end positions of the character substrings), with the obtained notations. Till this stage, the operations correspond to the operation B.

Then, the character input device 100 performs the operation C. More particularly, the operation C includes the operations performed Steps S16 to S18 explained with reference to FIG. 6 according to the first embodiment.

Summary

As described above, in the character input device 100 according to the second embodiment, the input character string obtainer 11 receives input of characters from the user and obtains the input character string CS. Then, in the character input device 100, the termination inserter 22 inserts character input termination symbols in the input character string CS at the character positions specified by the user. Subsequently, in the character input device 100, the word notation list generator 12 divides the input character string CS, which has termination symbols inserted therein, into a plurality of character strings; and generates the word notation list WL that includes the words of all combinations which can serve as the reading of the divided character strings. Then, in the character input device 100, the N-best-routes determiner 14 treats the word notation list WL as a directed acyclic graph; infers the user-intended word notation and infers the relations of connection (combinations) between the word notations; and determines N number of best routes BR each of which has a high likelihood (a high probability) of serving as the user-intended notation candidate. Subsequently, in the character input device 100, the layout information generator 15 extracts, from the group of word notations included in the N number of best routes BR, the word notations to be displayed; and generates the layout information for the purpose of displaying the word notation string of the first-ranked route BR1, which has the highest likelihood of serving as the user-intended notation candidate, as well as displaying the extracted word notations as the notation candidates. Subsequently, in the character input device 100, the layout information outputter 18 outputs the layout information.

With that, in the character input device 100 according to the second embodiment, an environment is provided in which, without making the user input the characters of a phrase or a word to the end, it becomes possible to make transition to inputting the next phrase or the next word. Moreover, in the character input device 100 according to the second embodiment, in such a character input environment, the word notation string having the highest likelihood of serving as the user-intended word notation string is displayed along with the word notations to be displayed. Consequently, an environment is provided in which it is possible to present the notation candidates with respect to the input character string CS. As a result, in the character input device 100 according to the second embodiment, it becomes possible to provide a high-speed character input service. In addition to that, in the character input device 100 according to the second embodiment, without making the user perform the operations such as instructing a conversion, selecting the intended notations, and correcting the separation according to phrases or words; it is possible to present the user-intended notations automatically as well as at a high probability from the input character string CS. With that, even in a situation in which, for example, the user is listening to a person talk during a meeting or a lecture and it is difficult for him or her to constantly look at the screen for the purpose of performing character input to take notes; the character input device 100 according to the second embodiment can provide a service that enables the user to efficiently carry on with the character input with bare minimum attentiveness and bare minimum quantity of work (amount of typing). That is, the character input device 100 according to the second embodiment enables achieving enhancement in the user-friendliness.

### Third Embodiment

Unlike the first and second embodiments, in a third embodiment, a case is considered in which English language sentences are input using the keypad of a cellular phone. Herein, the single-tap input method is used as the representative input-saving method. In the single-tap input method, usually, if the user inputs only once the key equivalent to each character of the intended word; the system presents the words that are imaginable from the combinations of those keys, and prompts the user to select a word. However, according to the invention, it is not necessary for the user to perform selection, and the text having a high probability of serving as the text input by the user is automatically displayed.

Herein, the overall sequence of operations is identical to the explanation given with reference to FIG. 1 according to the first embodiment. Hence, regarding the common constituent elements with the first embodiment, the explanation is not repeated.

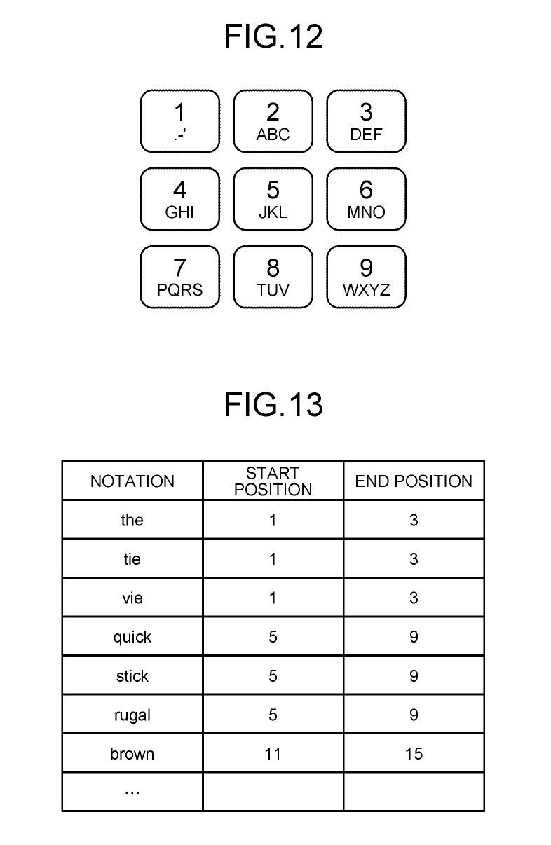

FIG. 12 is a diagram illustrating an example of a keypad of a cellular phone according to the third embodiment. For example, to the key for “2”, the characters “A”, “B”, and “C” are assigned. The assignment of keys can be done in an arbitrary manner. Moreover, using a space key (not illustrated) or a right cursor key (not illustrated), it is possible to input a space.

FIG. 13 is a diagram illustrating an example of the word notation list according to the third embodiment. In FIG. 13 is illustrated an example of the word notation list that is generated by the word notation list generator 12 when a numerical string “843_{—}78425_{—}27696_{—}369_{—}58677_{—}6837_{—}843_{—}5299_{—}364” is input using the single-tap input method. Herein, it is assumed that spaces are invariably input between adjacent words. Hence, the start point of each word is confined either to the beginning of a sentence or to the character immediately after a space. Moreover, the end point of each word is confined either to the end of a sentence or to the character immediately before a space.

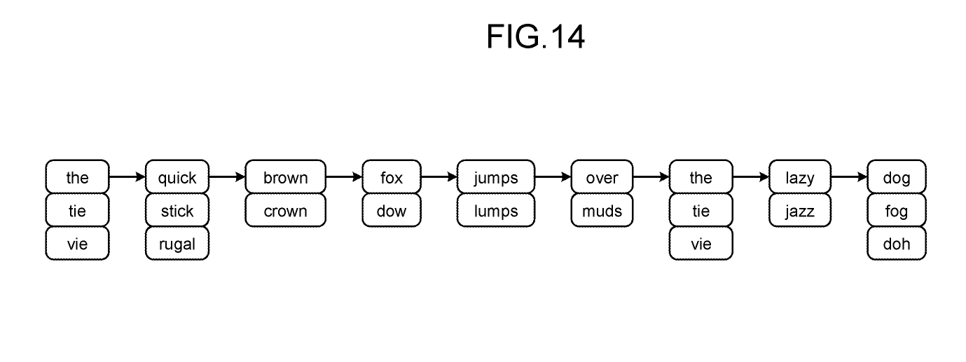

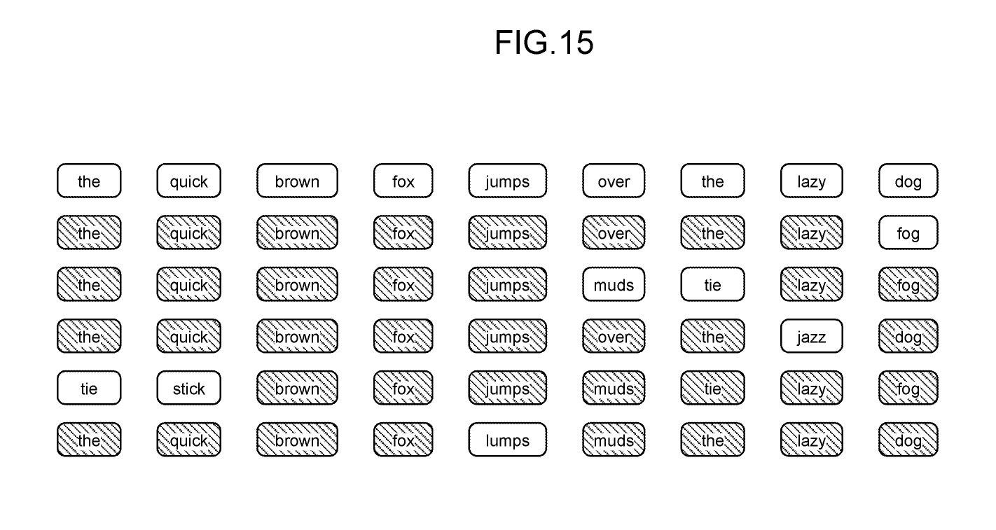

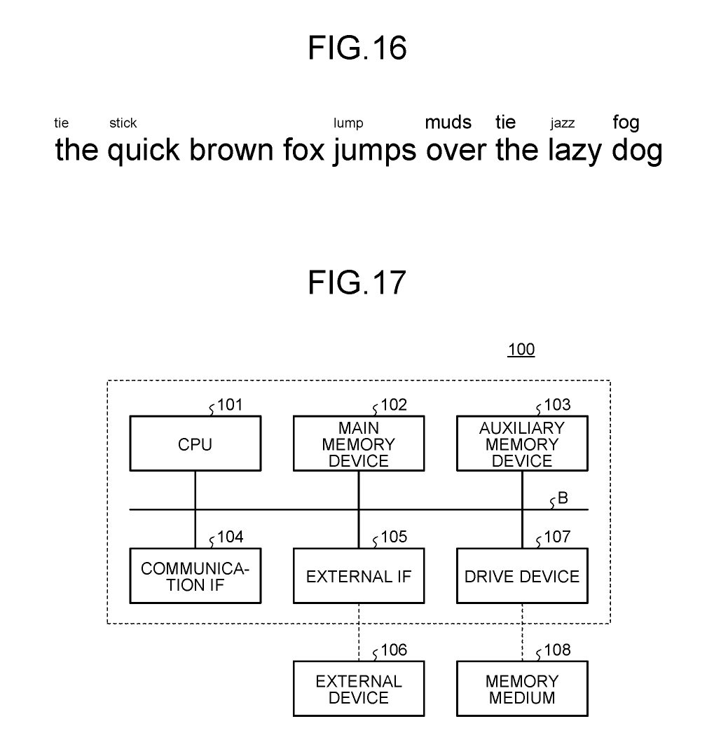

FIG. 14 is a diagram illustrating an example of a directed acyclic graph that is internally constructed from the word notation list by the N-best-routes determiner 14. Besides, the N-best-routes determiner 14 derives the N number of best routes and deletes words according to the method already explained with reference to FIG. 3. FIG. 15 is a diagram illustrating an example of the N number of best routes from which words are deleted. FIG. 16 is a diagram illustrating an example of the display result obtained according to layout information which is generated from the result of abovementioned deletion. In the example illustrated in FIG. 16, with respect to the first-ranked route “the quick brown fox jumps over the lazy dog” that is written in the first line in FIG. 15, the words which appear in the second-ranked route onward written in the second line onward in FIG. 15 and which remain undeleted are displayed using different font sizes according to the ranking.

Thus, according to the third embodiment, even in the case in which the input-saving method for English language is implemented in a cellular phone, the user can achieve the desired display without having to perform candidate selection.

Device

FIG. 17 is a diagram illustrating a configuration example of the character input device 100 according to the embodiments. As illustrated in FIG. 17, the character input device 100 according to the embodiments includes a central processing unit 101 (CPU) 101 and a main memory device 102. In addition, the character input device 100 includes an auxiliary memory device 103, a communication interface (IF) 104, an external IF 105, and a drive device 107. Moreover, in the character input device 100, the constituent elements are interconnected by a bus B. In this way, the character input device 100 according to the embodiments is equivalent to a typical information processing device.

The CPU 101 is a processor that controls the entire character input device 100 and implements the installed functions. The main memory device 102 is a memory device (memory) that is used to store computer programs and data in predetermined memory areas. Examples of the main memory device 102 include a read only memory (ROM) and a random access memory (RAM). The auxiliary memory device 103 is a memory device having a greater memory capacity than the main memory device 102. Moreover, the auxiliary memory device 103 is a nonvolatile memory device such as a hard disk drive (HDD) or a memory card. Thus, for example, the CPU 101 reads computer programs and data from the auxiliary memory device 103, loads them in the main memory device 102, and executes the computer programs so as to control the entire character input device 100 and to implement the installed functions.

The communication IF 104 is an interface for connecting the character input device 100 to a data transmission path. As a result, the character input device 100 becomes able to perform data communication with an external device connected via the data transmission path. The external IF 105 is an interface for sending data to and receiving data from an external device 106. Examples of the external device 106 include a display device (such as a “display”), which displays a variety of information such as processing results, and an input device (such as a “numerical keypad”), which receives operation inputs. The drive device 107 is a control device that performs writing and reading operations with respect to a memory medium 108 that can be, for example, a flexible disk (FD), a compact disk (CD), or a digital versatile disk (DVD).

Meanwhile, in the character input device 100, in order to implement the character input function according to the embodiments, a computer program (a character input program) is executed so as to make the functional units perform coordinated operations. In this case, the computer program is recorded as an installable or executable file in a memory medium readable by a device (a computer) equipped with the execution environment. For example, in the case of the character input device 100, the computer program includes a module for each functional unit. The CPU 101 reads the computer program from the memory medium 108 and executes the computer program so that each functional unit is generated in a RAM serving as the main memory device 102. However, the method of providing the computer program is not limited to the method given above. Alternatively, for example, the computer program can be stored in an external device connected to Internet, and can be downloaded via a data transmission path. Still alternatively, the computer program can be stored in advance in a ROM serving as the main memory device 102 or in an HDD serving as the auxiliary memory device 103.

In the embodiments described above, the explanation is given for an example in which a typical information processing device serves as the environment in which software for implementing the character input function is installed. However, that is not the only possible case. Alternatively, for example, a cellular phone (not illustrated) or an information terminal (not illustrated) such as a tablet can also serve as the environment in which the software is installed.

Moreover, in the embodiments described above, the explanation is given for an example in which the character input function is implemented by installing software. However, that is not the only possible case. Alternatively, for example, some or all of the functional units that are used to implement the character input function can be implemented using hardware such as an “electronic circuit” or an “integrated circuit”.

Furthermore, in the embodiments described above, the explanation is given for an example of performing Japanese language input. However, that is not the only possible case. Alternatively, for example, the embodiments are also applicable to pinyin input of Chinese language.

Moreover, in the embodiments described above, the explanation is given for an example of implementing a typical character input method. However, that is not the only possible case. Alternatively, for example, it is possible to link the embodiments to a system that enables saving in the amount of input using a character input method such as T9 (Text on 9 keys).

Furthermore, in one of the embodiments described above, the explanation is given about a configuration in which the character input device 100 includes the input character string obtainer 11, the word notation list generator 12, the different-notation obtainer 13, the N-best-routes determiner 14, the layout information generator 15, the meaning information obtainer 16, the layout constraint obtainer 17, and the layout information outputter 18. Moreover, in one of the embodiments described above, the explanation is given about a configuration in which, in addition to the input character string obtainer 11, the word notation list generator 12, the different-notation obtainer 13, the N-best-routes determiner 14, the layout information generator 15, the meaning information obtainer 16, the layout constraint obtainer 17, and the layout information outputter 18; the character input device 100 also includes the termination instruction receiver 21, the termination inserter 22, and the left-hand matching different-notation obtainer 23. However, the functional configuration is not limited to these cases. Alternatively, for example, the configuration can be such that the character input device 100 is connected to an external device, which has some functions of the abovementioned functional units, via the communication IF 104; performs data communication with the connected external device; makes the functional units operate in a coordinated manner; and provides the abovementioned character input function. More particularly, the character input device 100 can perform data communication with an external device that includes the different-notation obtainer 13 and the meaning information obtainer 16; and can make those functional units perform operations in a coordinated manner so as to provide the abovementioned character input function. Thus, the character input device 100 according to the embodiments described above can be implemented in a cloud environment too.

Meanwhile, although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A character input device comprising:
a first obtainer to receive an input of characters from a user and obtain an input character string;
a determiner to, from the input character string, infer word notations intended by the user and relations of connection between the word notations, and to determine routes each of which represents the relation of connection having a high likelihood of serving as a notation candidate intended by the user;
a first generator to, from a group of word notations included in the routes, extract the word notations to be output and generate layout information used in outputting the extracted word notations as the notation candidates; and
an outputter to output the layout information.

2. The device according to claim 1, further comprising:
a second obtainer to obtain a different notation with respect to a character substring included in the input character string; and
a second generator to generate word notation information in which the obtained different notation is held as the word notation of the notation candidate, wherein
the determiner
connects the word notations held in the word notation information according to combinations inferred from a reading of the input character string, and
treats a single word notation string, which is formed as a result of connection, as a single route and determines the routes in descending order of the likelihood of serving as a notation candidate intended by the user.

3. The device according to claim 1, wherein, from a group of word notations that is included in the routes, the first generator identifies the word notation that is not to be output as the notation candidate, and deletes the identified word notation to extract the word notation to be output as the notation candidates.

4. The device according to claim 3, wherein
the first generator determines whether or not a word class of the word notation is a predetermined classification word class, and
when a determination result indicates the word class is the predetermined classification word class, the first generator identifies the word notation corresponding to the word class as the word notation not to be output as the notation candidate.

5. The device according to claim 3, further comprising a third obtainer to obtain meaning information of the word notations, wherein
based on the meaning information, the first generator calculates distances, each of which represents closeness in meaning among the word notations, and
when a calculation result indicates that the word notations having same meaning or the word notations having a close meaning are present, the first generator identifies the word notation, which is included in the route having a lower likelihood of serving as a notation candidate intended by the user, as the word notation not to be output as the notation candidate.

6. The device according to claim 2, wherein the first generator generates the layout information which is used in outputting the word notation string of a first-ranked route, which has the highest likelihood of serving as a notation candidate intended by the user, and outputting the extracted word notation.

7. The device according to claim 6, wherein the first generator generates the layout information which is used in outputting the word notation string of the first-ranked route and outputting the word notation that is extracted from routes, starting from a second-ranked route onward, having a relatively lower likelihood as compared to the first-ranked route.

8. The device according to claim 7, wherein the first generator generates the layout information which is used in outputting, at a neighboring position to the word notation string of the first-ranked route, the word notation extracted from routes starting from the second-ranked route onward.

9. The device according to claim 7, wherein the first generator generates the layout information which is used in outputting, in between the word notation string of the first-ranked route, the word notation extracted from routes starting from the second-ranked route onward.

10. The device according to claim 7, wherein the first generator generates the layout information which is used in outputting the word notation string of the first-ranked route and outputting the word notation extracted from routes, starting from the second-ranked route onward, in different formats.

11. The device according to claim 10, wherein the first generator generates the layout information which is used in displaying the word notation string of the first-ranked route and displaying the word notation extracted from routes, starting from the second-ranked route onward, in different display formats.

12. The device according to claim 1, further comprising a fourth obtainer to obtain a layout constraint for an environment of outputting the notation candidate, wherein
the first generator generates the layout information according to an output format satisfying the layout information.

13. The device according to claim 1, further comprising:
a receiver to receive an instruction for terminating an input of characters;
an inserter to, in response to the received instruction, insert a termination symbol, which indicates that the input of characters has been terminated, in the input character string; and
a fifth obtainer to obtain a left-hand matching different notation with respect to a character substring included in the input character string, wherein
the second generator
determines whether or not the termination symbol is included in a character substring included in the input character string, and
if a determination result indicates that the termination symbol is included in the character substring, makes use of the fifth obtainer to obtain the left-hand matching different notation with respect to the character substring.

14. The device according to claim 1, wherein the layout information is used in displaying the extracted word notations.

15. A character input method comprising:
receiving an input of characters from a user to obtain an input character string;
inferring, from the input character string, word notations intended by the user and relations of connection between the word notations to determine routes each of which represents the relation of connection having a high likelihood of serving as a notation candidate intended by the user;
extracting, from a group of word notations included in the routes, the word notations to be output and generating layout information used in outputting the extracted word notations as the notation candidates; and
outputting the layout information.

16. A computer program product comprising a computer readable medium containing a character input program, wherein the character input program, when executed
receiving an input of characters from a user to obtain an input character string;
inferring, from the input character string, word notations intended by the user and relations of connection between the word notations to determine routes each of which represents the relation of connection having a high likelihood of serving as a notation candidate intended by the user;
extracting, from a group of word notations included in the routes, the word notations to be output and generating layout information used in outputting the extracted word notations as the notation candidates; and
outputting the layout information.
